(19) United States
(12) Patent Application Publication
(10) Pub. No.: US 2026/0329615 A1
(43) Pub. Date: Oct. 22, 2026

(54) RESOURCE COORDINATION AND OPTIMIZATION FOR VIRTUALIZATION-AWARE APPLICATIONS IN MULTI-TENANT SYSTEMS

(71) Applicant: Kyndryl, Inc., New York, NY (US)

(72) Inventors: Moncef Benboubakeur, Prague (CZ); Malini Appalla, Herndon, VA (US)

(21) Appl. No.: 19/185,362

(22) Filed: Apr. 22, 2025

(51) Int. Cl. G06F 9/455

(52) U.S. Cl. CPC G06F 9/45558; G06F 2009/45591; G06F 2009/45595

(57) ABSTRACT

Embodiments include centralized resource coordination and optimization for virtualization-aware applications in a multi-tenant virtualized environment. Aspects include receiving, by a virtual machine (VM) coordination layer, a plurality of requests from multiple virtualization-aware applications running within a VM, enriching one or more of the plurality of requests, by a policy and context manager of the VM coordination layer, with application-specific policies and contextual information, and aggregating multiple requests of the plurality of requests by combining requests from the multiple virtualization-aware applications running within the VM into an optimized request. Aspects also include transmitting the optimized request to a virtualization system that manages the VM and notifying the VM of action taken by the virtualization system in response to the optimized request.

### BACKGROUND

The present invention generally relates to computer systems, and more specifically, to computer-implemented methods, computer systems, and computer program products configured to provide resource coordination and optimization for virtualization-aware applications in multi-tenant virtualized environments.

In modern computing environments, virtualization is often used to optimize resource utilization and enhance operational efficiency. Virtual machines and containerized applications offer flexibility and scalability, allowing multiple applications to share the same physical resources. However, managing resources dynamically in these virtualized environments presents significant challenges, particularly for resource-intensive applications with unpredictable workloads. Traditional systems often rely on reactive resource allocation, provisioning resources only after performance issues arise, which can lead to inefficiencies, delays, and increased operational costs. Additionally, these systems typically focus on managing resources at the virtual machine or hypervisor level, with limited consideration for the specific needs and internal states of the applications running within them.

Currently, applications cannot proactively request resources or communicate their requirements to the underlying virtualization system, resulting in a disconnect between application behavior and system response. This gap can lead to resource contention, conflicts, and suboptimal performance, especially for tasks requiring precise and timely resource allocation. Furthermore, existing feedback mechanisms often operate coarse-grained, focusing on host-level metrics rather than application-specific insights, limiting their ability to optimize resource allocation in real-time. Accordingly, there is a need for a system that enables applications to become virtualization-aware, allowing them to manage resources proactively and interact intelligently with the virtualization system, thereby enhancing performance, reducing resource wastage, and improving overall efficiency.

### SUMMARY

Embodiments of the present invention are directed to computer-implemented methods for resource coordination and optimization for virtualization-aware applications in multi-tenant virtualized environments. A non-limiting computer-implemented method includes receiving, by a virtual machine (VM) coordination layer, a plurality of requests from multiple virtualization-aware applications running within a VM, enriching one or more of the plurality of requests, by a policy and context manager of the VM coordination layer, with application-specific policies and contextual information, and aggregating multiple requests of the plurality of requests by combining requests from the multiple virtualization-aware applications running within the VM into an optimized request. The method also includes transmitting the optimized request to a virtualization system that manages the VM and notifying the VM of action taken by the virtualization system in response to the optimized request. The technical benefits of this method include enhanced resource efficiency and reduced communication overhead by aggregating multiple application requests into a single optimized request, which streamlines interactions with the virtualization system. Additionally, by enriching requests with application-specific policies and contextual information, the method ensures that resource allocation is precisely tailored to the needs of each application, improving overall system performance and responsiveness in multi-tenant virtualized environments.

In addition to the one or more features described herein, the method also includes monitoring performance and resource usage of the multiple virtualization-aware applications running within the VM and enabling adaptive adjustments to future resource allocations and using machine learning algorithms to analyze historical data regarding the performance and resource usage of the multiple virtualization-aware applications running within the VM. Technical benefits of this feature include enhanced resource optimization, allowing for data-driven adjustments that improve application performance and reduce resource wastage.

In addition to the one or more features described herein, the method also includes prioritizing, by the VM coordination layer, the plurality of requests based on predefined quality of service policies of the VM. Technical benefits of this feature include ensuring that critical applications receive the necessary resources to maintain service levels, thereby enhancing overall system reliability and user satisfaction.

In addition to the one or more features described herein, the method also includes resolving conflicts among concurrent requests from different applications of the multiple virtualization-aware applications, by the VM coordination layer, to avoid resource contention. Technical benefits of this feature include maintaining system stability and performance by preventing resource bottlenecks and ensuring fair resource distribution among applications.

In addition to the one or more features described herein, the method also includes applying rate limiting, by the VM coordination layer, to control a frequency and volume of requests forwarded by the VM to the virtualization system. Technical benefits of this feature include preventing system overload and ensuring efficient processing of requests, thereby maintaining optimal system performance.

In addition to the one or more features described herein, the VM is associated with a tenant of a cloud environment managed by the virtualization system and wherein the optimized request is transmitted to the virtualization system via a tenant coordination layer that manages a plurality of VMs including the VM. Technical benefits of this feature include streamlined resource management and improved scalability by centralizing request handling for multiple VMs under a single tenant.

In addition to the one or more features described herein, the tenant coordination layer is configured to aggregate and optimize resource requests, received from multiple VM coordination layers of the VMs of the tenant. Technical benefits of this feature include enhanced efficiency in resource allocation by reducing redundancy and optimizing resource distribution across the tenant's VMs.

In addition to the one or more features described herein, all communication between the VM coordination layers of the VMs of the tenant and the virtualization system is handled by the tenant coordination layer. Technical benefits of this feature include reduced communication overhead and improved coordination, leading to faster response times and more efficient resource management.

In addition to the one or more features described herein, the tenant coordination layer is configured to provide tenant-specific prioritization and policy application for strategic allocation of resources across VMs based on tenant-defined requirements and QoS policies. Technical benefits of this feature include tailored resource management that aligns with tenant priorities, ensuring that resources are allocated in a manner that meets specific business needs and service level agreements.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system configured to provide resource coordination and optimization for virtualization-aware applications in multi-tenant virtualized environments according to one or more embodiments of the present invention;

FIG. 3 depicts a system diagram illustrating the interaction between virtualization-aware applications, VM coordination layers, tenant coordination layers, and the virtualization system environments according to one or more embodiments of the present invention;

FIG. 4 depicts a block diagram illustrating a system for centralized resource coordination and optimization in virtualization-aware environments according to one or more embodiments of the present invention;

FIG. 5 depicts a block diagram illustrating a system for centralized resource coordination and optimization in virtualization-aware environments according to one or more embodiments of the present invention;

FIG. 6 depicts a flow chart diagram of a method for managing resource allocation and deallocation in a virtualization-aware system according to one or more embodiments of the present invention;

FIG. 7 depicts a flow chart diagram illustrating a method for managing resource allocation in a multi-tenant virtualized environment according to one or more embodiments of the present invention;

FIG. 8 depicts a flow chart diagram of a method for centralized resource coordination in a virtualized environment according to one or more embodiments of the present invention;

FIG. 9 depicts a cloud computing environment according to one or more embodiments of the present invention; and

FIG. 10 depicts abstraction model layers according to one or more embodiments of the present invention.

### DETAILED DESCRIPTION

The adoption of virtualization-aware architectures introduces significant complexity for software developers, as it requires them to configure and manage numerous resource management and virtualization-aware components within each application. This architecture demands new skills and specialized knowledge, increasing the complexity for developers in virtualization-aware environments. To alleviate this complexity, embodiments of the invention centralize all virtualization-aware functionalities within one or more coordination layers at the VM and/or tenant level. By consolidating resource management tasks into shared modules within the VM coordination layer, the system abstracts virtualization-aware tasks from individual applications, enabling developers to focus on application functionality rather than intricate resource management configurations.

Centralizing resource management and virtualization-aware functionalities significantly lowers the skill requirements for developers working with virtualization-aware applications. This approach offers several key benefits. First, it reduces the learning curve, allowing developers to concentrate on application-specific logic rather than mastering complex resource and virtualization management, thereby accelerating development and reducing training requirements. Second, it minimizes the risk of misconfigurations, as standardized, centralized management of virtualization-aware functionalities enhances the reliability and stability of applications within virtualized environments. Third, it enables faster development cycles, as simplified resource management through shared modules allows development teams to deploy and iterate on applications more quickly, without the need to configure resource and feedback handling for each application individually.

Additionally, the coordination layer supports scalability with minimal developer intervention. As applications grow or new applications are added within the same VM or tenant, the coordination layer seamlessly scales resource management without requiring additional configurations from developers. Finally, it ensures consistent Quality of Service (QoS), with built-in prioritization and QoS management, assuring developers that application performance standards are maintained across applications, even in resource-constrained environments.

One or more embodiments described herein can utilize machine learning techniques to perform tasks, such as classifying a feature of interest. More specifically, one or more embodiments described herein can incorporate and utilize rule-based decision-making and artificial intelligence (AI) reasoning to accomplish the various operations described herein. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful for tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

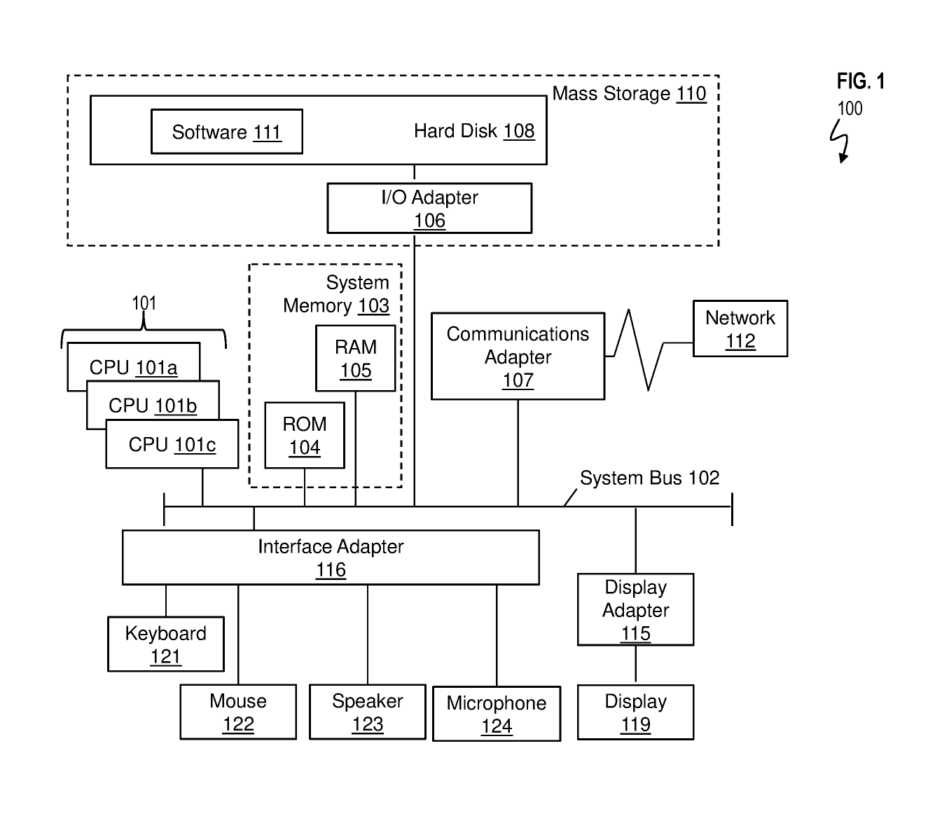

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read-only memory, flash memory, or any other suitable memory system.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program products and the execution of such instructions are discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics-intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the Internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein concerning computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

As used herein, an application is a program or computer code that is either bundled to run together in one machine or several components of the program that are deployed across multiple machines, sometimes running within another software package such as an operating system, a virtualized machine or a container, and sometimes deployed on a software platform. In exemplary embodiments, the application interacts with other software programs or components of its own stack to produce a result for the end user. Typically, an application is created to produce a result, and that result may be derived after running several smaller tasks that need to use system resources to complete the task.

As used herein virtualization refers to a software abstraction layer added on top of physical computer hardware enabling the division and distribution of the hardware resources such as core, memory, storage, and network bandwidth. It includes any execution environment that supports virtual machines, containers, web servers, etc. such as container environment, hypervisor, host OS, etc. Any environment that allows isolation of application code from the runtime environment and handles underlying application resource requirements is described as a virtualized environment.

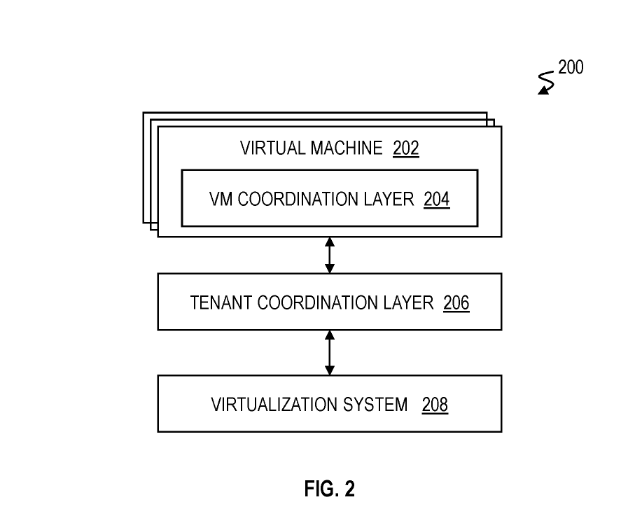

Referring now to FIG. 2, a block diagram of a system 200 configured to facilitate efficient resource management in virtualized environments according to one or more embodiments is shown. The system 200 includes one or more Virtual Machines (VMs) 202, which serve as the primary unit of computation within the virtualized infrastructure. The virtual machine 202 can operate on one or more computers systems, such as computer system 100. The virtual machine 202 can utilize any functionality and features of the computer system 100 in FIG. 1 including various hardware components and various software applications such as software 111 which can be executed as instructions on one or more processors 101 in order to perform actions according to one or more embodiments of the invention. Each VM 202 operates as an isolated environment capable of running its own operating system and applications, thereby providing the necessary abstraction from the underlying physical hardware. In exemplary embodiments, each VM 202 is capable of hosting multiple applications concurrently, each potentially requiring different resources and configurations.

In exemplary embodiments, the VM coordination layer 204 is configured to manage and optimize resource requests from virtualization-aware applications executing on the VM 202. The VM coordination layer 204 functions as an intermediary between the applications and the virtualization system 208, ensuring that resource requests are handled efficiently and in line with predefined policies. In exemplary embodiments, the VM coordination layer 204 consolidates resource requests, applies QoS policies, and resolves conflicts to prevent resource contention. By performing these functions, the VM coordination layer 204 enhances the performance and stability of applications running within the VM 202, particularly in environments with high density where resource demands can change rapidly.

In exemplary embodiments, the tenant coordination layer 206 functions at a higher level than the VM coordination layer 204, gathering resource requests across various VMs that belong to the same tenant. In the context of virtualized computing environments, the tenant is an individual or organization that owns or leases a portion of the computing resources within a shared infrastructure. Each tenant operates independently, with its own set of virtual machines (VMs) and applications, often within a multi-tenant environment where multiple tenants share the same physical hardware resources. The tenant coordination layer 206 is responsible for managing and optimizing resource requests across various VMs that belong to the same tenant, ensuring efficient resource allocation and prioritization based on tenant-specific policies and requirements. This layer helps streamline resource management by consolidating requests and reducing communication overhead with the virtualization system, thereby enhancing scalability and performance in high-density environments.

In exemplary embodiments, the tenant coordination layer 206 layer offers a cohesive interface for managing resources at the tenant level, enabling more strategic allocation based on tenant-specific priorities and policies. The tenant coordination layer 206 decreases communication overhead with the virtualization system by combining requests from all VMs under a single tenant, thus enhancing efficiency and scalability. Additionally, the tenant coordination layer 206 may be configured to prioritize resource allocation during peak demand periods, ensuring that applications requiring high performance receive the necessary resources to maintain optimal operation.

In exemplary embodiments, the virtualization system 208 is the infrastructure that supports the execution of virtual machines (VMs) and the allocation of resources. The virtualization system 208 system is responsible for provisioning and managing the physical resources, such as CPU, memory, and storage, which are virtualized and made available to the VMs. The virtualization system 208 interacts with both the VM coordination layer 204 and the tenant coordination layer 206 to fulfill resource requests and provide feedback on resource availability.

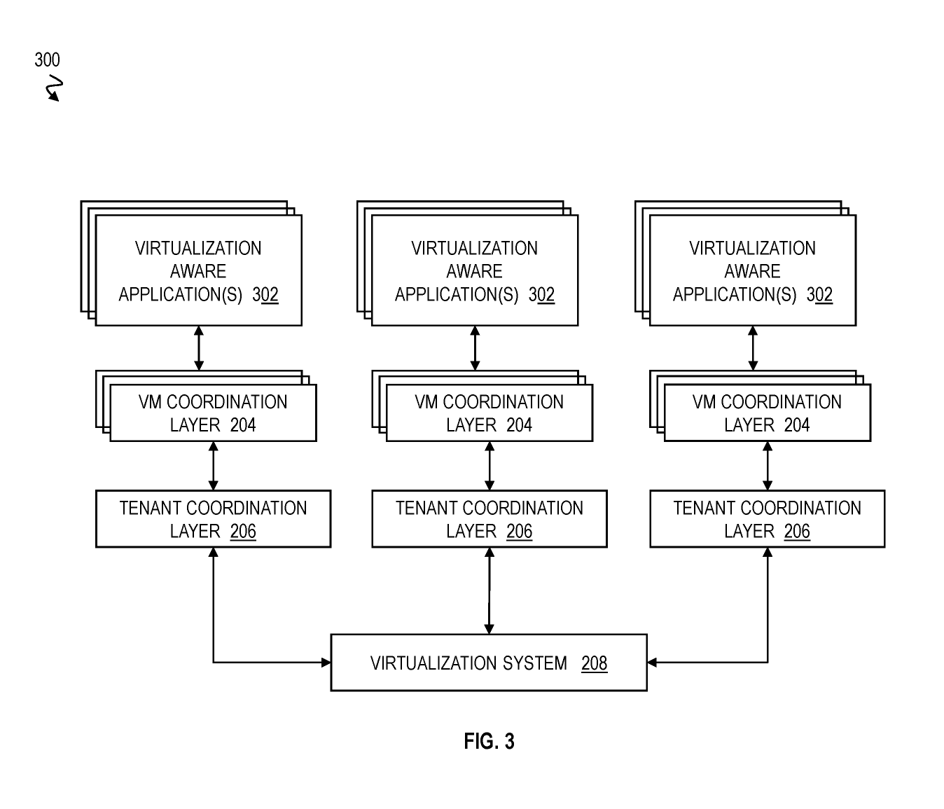

Referring now to FIG. 3, a block diagram of a system 300 configured to facilitate centralized resource coordination and optimization for virtualization-aware applications within a multi-tenant virtualized environment according to one or more embodiments is shown. In exemplary embodiments, the virtualization-aware application 302 is a software entity that is aware of the virtualized environment in which it operates. These applications can directly request resources from their hosting environments based on their internal needs. The virtualization-aware application 302 interacts with the VM coordination layer 204 to ensure that resource requests are efficiently managed and fulfilled. This interaction allows for the optimization of resource usage and the minimization of resource contention within the virtualized environment. In exemplary embodiments, the virtualization-aware application 302 is designed to take advantage of the capabilities of the VM coordination layer 204 to enhance performance and stability, particularly in high-density environments where resource demands can fluctuate rapidly. The VM coordination layer 204 serves as an intermediary between the virtualization-aware applications 302 and the virtualization system 208. The VM coordination layer 204 is responsible for managing and optimizing resource requests from applications executing on the virtual machine 202. The VM coordination layer 204 ensures that resource requests are handled efficiently and in line with predefined policies, thereby preventing bottlenecks and inefficient allocation.

In the system depicted in FIG. 3, the data flow for resource requests begins with the virtualization-aware applications 302, which are capable of recognizing their virtualized environment and directly requesting resources based on their internal needs. These applications execute on the virtual machine 202 and send resource requests to the VM coordination layer 204, which serves as an intermediary between the applications and the virtualization system 208.

Upon receiving resource requests from applications 302, the VM coordination layer 204 first attempts to service these requests using the resources available within the virtual machine 202. The VM coordination layer 204 evaluates resource requests, applies QoS policies, and resolves conflicts to prevent resource contention. If the VM coordination layer 204 can fulfill the requests with the resources at its disposal, it does so, thereby optimizing resource usage and minimizing the need for further escalation.

However, if the VM coordination layer 204 is unable to fully service the requests due to resource limitations, it consolidates any unfulfilled requests and forwards them to the tenant coordination layer 206. The tenant coordination layer 206 operates at a higher level, gathering resource requests across various VMs that belong to the same tenant. This layer offers a cohesive interface for managing resources at the tenant level, enabling more strategic allocation based on tenant-specific priorities and policies.

The tenant coordination layer 206 attempts to service the consolidated requests using resources available across the tenant's VMs. It prioritizes resource allocation based on tenant-specific policies and requirements, ensuring efficient resource distribution. If the tenant coordination layer 206 can fulfill the requests, it does so, thereby reducing communication overhead with the virtualization system 208.

In cases where the tenant coordination layer 206 is unable to fully service the requests, it further consolidates the unfulfilled requests and forwards them to the virtualization system 208. The virtualization system 208 is responsible for provisioning and managing the physical resources, such as CPU, memory, and storage, which are virtualized and made available to the VMs. The virtualization system 208 interacts with both the VM coordination layer 204 and the tenant coordination layer 206 to fulfill resource requests and provide feedback on resource availability.

This hierarchical approach to resource request management ensures that requests are handled efficiently and in line with predefined policies, enhancing the performance and stability of applications running within the virtualized environment. By centralizing resource requests and virtualization-specific actions at both the VM and tenant levels, the system addresses inefficiencies, scalability limitations, and development complexities introduced by independent application management in virtualized and multi-tenant environments.

In the system 300 depicted in FIG. 3, the VM coordination layer 204 and the tenant coordination layer 206 employ various policies to determine the allocation of resources when the total requested resources exceed the available resources. These policies are designed to ensure efficient and fair distribution of resources, maintaining system stability and performance. In exemplary embodiments, QoS policies are applied by both the VM coordination layer 204 and the tenant coordination layer 206 to prioritize resource requests. These policies define the minimum acceptable performance levels for applications, ensuring that critical applications receive the necessary resources to maintain their functionality. Applications with higher QoS requirements are prioritized over those with lower requirements, ensuring that essential services remain uninterrupted.

In exemplary embodiments, resource requests are evaluated based on predefined priority levels. Applications or VMs with higher priority, such as those supporting mission-critical tasks or real-time operations, are given precedence in resource allocation. This ensures that the most important applications receive the resources they need, even during periods of high demand. In exemplary embodiments, a policy and context manager enriches resource requests with contextual information, such as task priority, workload type, and duration. In exemplary embodiment, the request specifies a type, a quantity, and a duration for the resources requested for the application to perform a particular task. In exemplary embodiments, a type of resource refers to the category or kind of resource being requested. Examples of resource types include CPU, memory, storage, or network bandwidth. For instance, an application might request additional CPU resources to handle a computationally intensive task. In exemplary embodiments, a quantity indicates the amount or extent of the resource being requested. For example, if the type of resource is memory, the quantity might be specified as 4 GB of RAM. This helps in determining how much of the resource is needed to fulfill the application's requirements. In exemplary embodiments, the duration specifies the length of time for which the resources are needed. For example, an application might request additional CPU resources for a duration of 2 hours to complete a specific processing task. Specifying the duration helps the virtualization system manage and allocate resources efficiently over time. This enrichment allows the coordination layers to make informed decisions about resource allocation, aligning requests with application-specific policies and tenant-level priorities.

In exemplary embodiments, when multiple requests compete for limited resources, the coordination layers employ conflict resolution mechanisms to manage contention. These mechanisms ensure the fair distribution of resources by balancing the needs of different applications and VMs, preventing any single entity from monopolizing resources. To prevent system overload, the coordination layers may apply rate limiting and throttling to control the frequency and volume of resource requests. This helps manage the flow of requests, ensuring that the virtualization system is not overwhelmed by excessive demand.

At the tenant level, the tenant coordination layer 206 applies policies that reflect the specific needs and priorities of the tenant. These policies may include resource caps, allocation preferences, and strategic priorities, allowing for customized resource management that aligns with the tenant's objectives. In exemplary embodiments, a performance and feedback tracker continuously monitors application performance and collects feedback on resource sufficiency. This data is used to refine resource allocation strategies, enabling adaptive adjustments based on real-time conditions and historical usage patterns. By employing these policies, the VM coordination layer 204 and the tenant coordination layer 206 ensure that resources are allocated efficiently and equitably, supporting the diverse needs of applications and tenants within the virtualized environment.

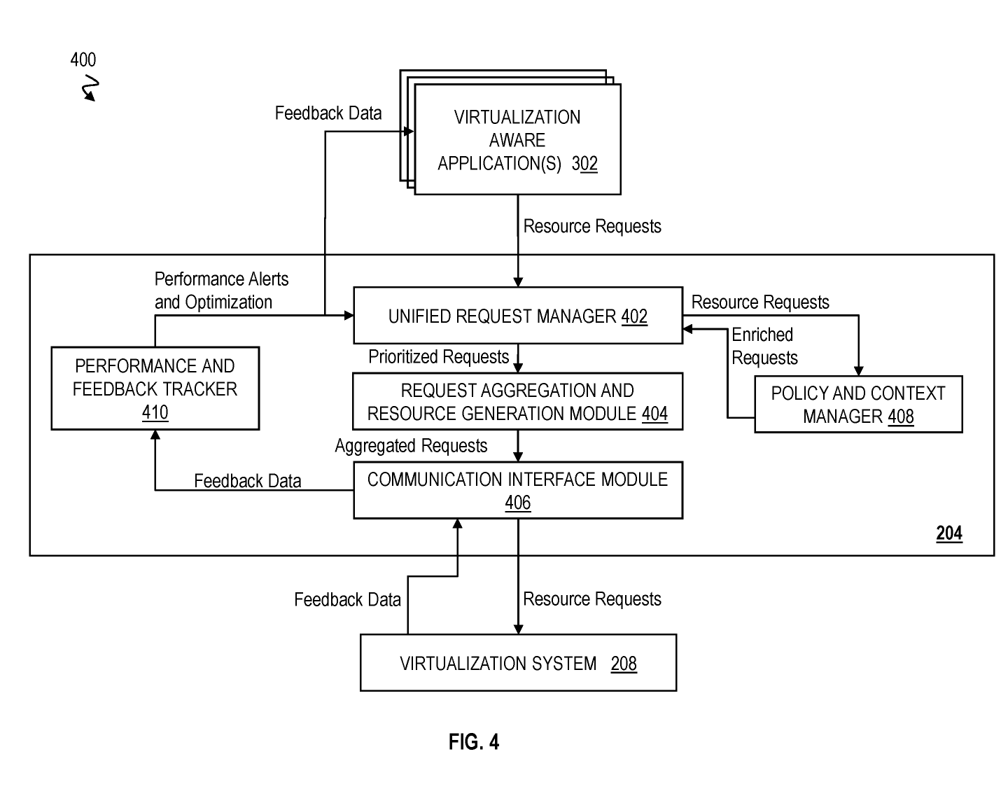

Referring now to FIG. 4 a diagram illustrating the architecture of a system 400 for centralized resource coordination and optimization in virtualization-aware environments in accordance with one or more embodiments is shown. The system 400 includes a VM coordination layer 204, which integrates several components to manage resource requests efficiently.

In exemplary embodiments, the unified request manager 402 is configured to manage all incoming resource and virtualization-specific requests from virtualization-aware applications 302. The unified request manager 402 centralizes the management of these requests, preventing each application from independently interfacing with the virtualization system 208. In exemplary embodiments, the unified request manager 402 prioritizes requests based on predefined QoS policies, ensuring that applications requiring immediate attention receive the necessary resources first. The unified request manager 402 also resolves conflicts among concurrent requests from different applications to avoid resource contention and applies rate limiting to control the frequency and volume of requests forwarded to the virtualization system, thereby reducing the potential for system overload.

In exemplary embodiments, the request aggregation and resource generation module 404 operates alongside the unified request manager 402 to enhance the efficiency of resource requests. The request aggregation and resource generation module 404 collects similar or redundant resource requests across applications within a virtual machine, reducing unnecessary communications with the virtualization system 208. By merging identical or overlapping requests into single, optimized requests, the request aggregation and resource generation module 404 improves the efficiency of resource utilization. In exemplary embodiments, the request aggregation and resource generation module 404 also predicts recurring resource needs across applications based on historical data, allowing for proactive, consolidated resource requests that improve the use of system resources.

In exemplary embodiments, the communication interface module 406 functions as the exclusive communication channel between the virtual machine or the tenant and the virtualization system 208. The communication interface module 406 consolidates and secures all requests and responses directed to and from the virtualization system, maintaining standardized communication settings and configurations, such as authentication protocols and error handling mechanisms. This approach ensures consistent and efficient interactions with the virtualization system, enhancing the security and reliability of the communication process.

In exemplary embodiments, the policy and context manager 408 enriches each resource request with application-specific policies and contextual information, such as task priority, workload type, and duration. The policy and context manager 408 ensures that each request aligns with developer-defined policies for each application, enabling context-aware resource allocation by consolidating policy and contextual information across applications. This enrichment process enhances coordination and reduces redundant processing of policies at the application level, allowing for more efficient and tailored resource management.

In exemplary embodiments, the performance and feedback tracker 410 consistently monitors application performance and resource usage within each virtual machine. Feedback is collected on resource sufficiency and actions specific to virtualization, allowing for adaptive adjustments to future resource allocations. By employing machine learning algorithms to analyze historical data and real-time feedback, the performance and feedback tracker 410 consistently refines predictions and enhances the accuracy of aggregated resource requests for future operations. This feedback-driven approach maintains responsive and optimized resource management over time.

In exemplary embodiments, the machine learning algorithms employed by the performance and feedback tracker 410 may be configured to produce several types of outputs to enhance resource management. For instance, the algorithms might generate resource allocation recommendations based on historical data and real-time feedback. If an application frequently underutilizes its allocated memory, the algorithm could suggest reducing the memory allocation for future similar tasks, thereby optimizing resource usage. Additionally, the algorithms could produce predictive alerts for potential resource shortages or bottlenecks. For example, if data indicates that a particular application tends to experience CPU spikes at certain times, the system could preemptively allocate additional CPU resources during those periods to prevent performance degradation.

The machine learning algorithms might also output efficiency metrics that quantify how well resources are being utilized. These metrics could include the percentage of allocated resources actually used, the average time resources remain idle, or the frequency of resource contention events, helping to identify areas for improvement in resource management. Furthermore, the algorithms could identify anomalies in resource usage patterns, such as unexpected spikes in network bandwidth or sudden drops in CPU utilization, which might indicate issues like a malfunctioning application or a security breach. Lastly, the algorithms could provide insights into long-term trends in resource usage, helping to forecast future needs. For example, if the data shows a steady increase in storage requirements over time, the system might recommend scaling up storage capacity to accommodate future growth. By leveraging these outputs, the performance and feedback tracker 410 can make adaptive adjustments to resource allocations, ensuring that the virtualized environment remains efficient, responsive, and well-optimized over time.

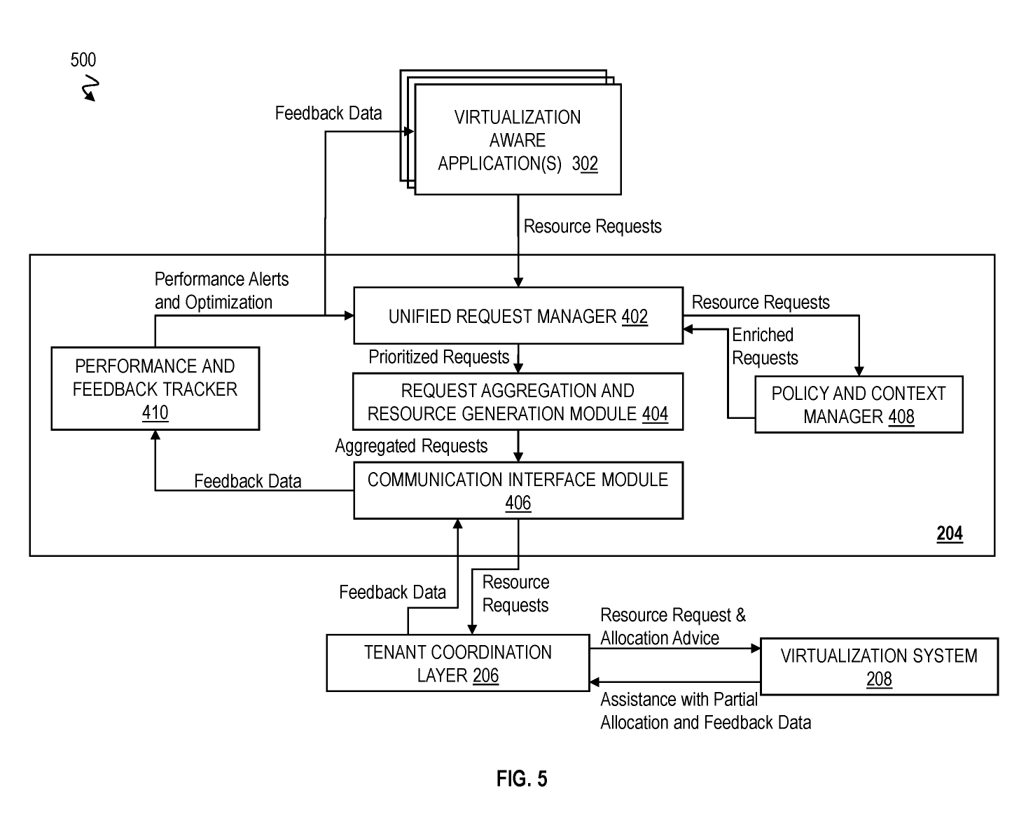

Referring now to FIG. 5, a diagram illustrating the architecture of a system 500 for centralized resource coordination and optimization in virtualization-aware environments in accordance with one or more embodiments is shown. The system 500 is similar to the system 400 shown in FIG. 4, but also includes a tenant coordination layer 206. In exemplary embodiments, the tenant coordination layer 206 is configured to manage and optimize resource requests across multiple virtual machines (VMs) that belong to the same tenant. The tenant coordination layer 206 operates at a higher level than the VM coordination layer 204, providing a strategic interface for resource management at the tenant level. When resource requests are received from the VM coordination layer 204, the tenant coordination layer 206 aggregates these requests, consolidating them to reduce redundancy and improve efficiency. The tenant coordination layer evaluates the aggregated requests based on tenant-specific policies and priorities, ensuring that resources are allocated in a manner that aligns with the tenant's objectives and QoS requirements.

If the tenant coordination layer 206 can fulfill the requests using resources available across the tenant's VMs, it does so, thereby optimizing resource distribution and minimizing the need for further escalation. However, if the total requested resources exceed the available resources, the tenant coordination layer 206 provides allocation advice to the virtualization system 208, assisting with partial allocation and offering guidance on optimal resource distribution based on tenant-defined priorities. In exemplary embodiments, the tenant coordination layer 206 also receives feedback data from the virtualization system 208, which it uses to refine its resource allocation strategies. This feedback-driven approach enables the tenant coordination layer 206 to adapt to changing conditions and improve the accuracy of future resource predictions, ensuring efficient and equitable resource management across the tenant's VMs. By centralizing resource requests and providing strategic allocation advice, the tenant coordination layer 206 enhances the scalability and performance of the virtualized environment, supporting the diverse needs of applications and tenants.

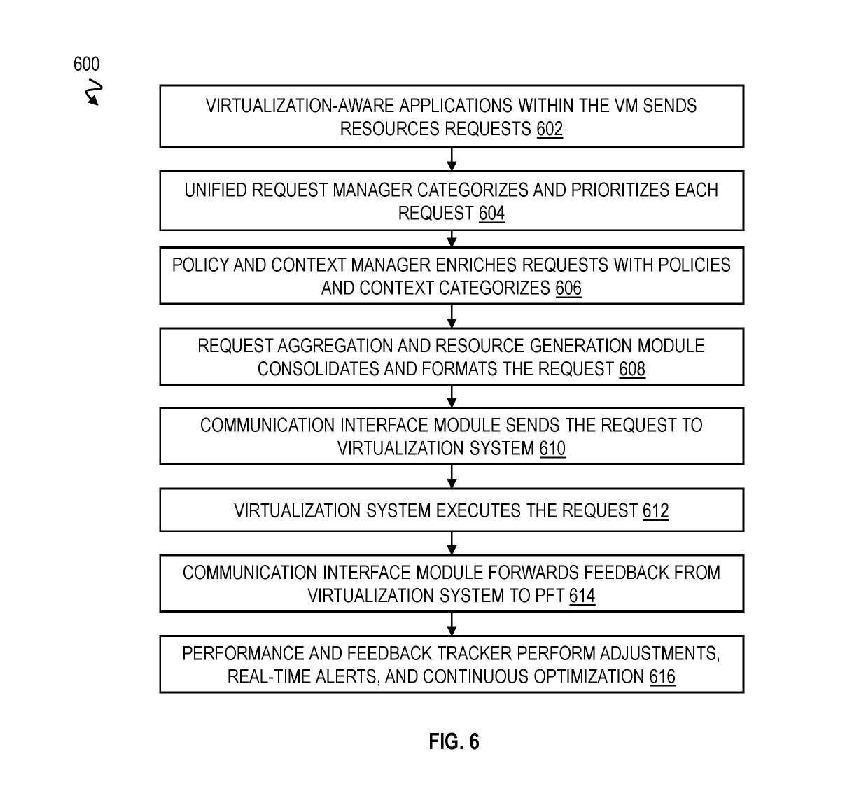

FIG. 6 illustrates a flow chart of a computer-implemented method 600 for managing resource allocation and deallocation by a VM coordination layer in a virtualization-aware system according to one or more embodiments. The method 600 begins at block 602, where virtualization-aware applications within the virtual machine send resource requests. For example, an application may request additional CPU resources to handle a spike in user activity.

At block 604, the unified request manager categorizes and prioritizes each request, ensuring that critical applications receive the necessary resources first. For instance, the manager might prioritize a request from a real-time video processing application over a background data analysis task due to its higher QoS requirements. Next, as shown at block 606, the policy and context manager enriches the requests with policies and contextual information, aligning them with application-specific requirements. For example, it may add information about the expected duration and priority of the task, ensuring that the request aligns with predefined policies.

The process continues at block 608, where the request aggregation and resource generation module consolidates and formats the requests, optimizing them for efficient communication. For instance, if multiple applications request similar resources, the module may combine these into a single, optimized request to reduce communication overhead. Next, as shown at block 610, the communication interface module sends the formatted requests to the virtualization system. This step involves establishing a secure connection and ensuring that the requests are transmitted efficiently. For example, the module might use encryption protocols to secure the data during transmission.

The virtualization system then executes the requests at block 612, provisioning the necessary resources. For instance, it may allocate additional CPU cores to the virtual machine to meet the application's demands. Subsequently, at block 614, the communication interface module forwards feedback from the virtualization system to the performance and feedback tracker. This feedback includes information on resource availability and request fulfillment, allowing the system to adjust future allocations. The method 600 ends at block 616 with the performance and feedback tracker providing adjustments, real-time alerts, and continuous optimization based on the feedback received, ensuring that resource management remains responsive and efficient over time. For example, it may use machine learning algorithms to predict future resource needs and optimize allocations accordingly.

In a scenario of VM-level multi-application resource coordination, three applications within a virtual machine (VM) make different requests simultaneously. Application A requests to release some CPU resources as it finishes a high-computation task, Application B requests additional CPU resources to handle an upcoming workload spike, and Application C requests a snapshot of its current state for backup purposes. The process begins with the Unified Request Manager (URM), where Applications A, B, and C send their respective requests. The URM receives and categorizes these requests based on type and priority. Application A's request to release CPU is marked as a low-priority, non-urgent task, as it frees up resources without requiring immediate action. Application B's request for additional CPU is classified as high-priority due to the imminent workload spike, while Application C's snapshot request is treated as a medium-priority virtualization action, as it involves a one-time system operation for backup.

The URM applies conflict resolution and prioritization rules, processing Application B's high-priority request before Application A's release request. Application C's snapshot request is queued but treated independently, as it doesn't impact CPU allocation directly. The URM then forwards the prioritized and categorized requests to the Policy and Context Manager (PCM) for enrichment with policy and context details. The PCM retrieves application-specific policies and enriches each request. Application A's request is enriched with a low-priority, "resource deallocation" context, ensuring it doesn't interfere with critical tasks. Application B's request is enriched with a high-priority, "immediate allocation" context, with specific workload details added to prioritize it in case of resource contention. Application C's request is enriched with a medium-priority "one-time virtualization action" context, ensuring it is processed independently to avoid conflicts.

The PCM sends the enriched requests back to the URM, which re-evaluates request priorities and prepares them for further processing. Application B's additional CPU request is prioritized as the highest due to its critical nature, while Application A's CPU release request is queued to be processed after Application B's request. Application C's snapshot request is sent to be processed separately. The Request Aggregation and Resource Generation Module (RAR) receives the prioritized requests from the URM and processes Application B's CPU request first. Recognizing that Application A is releasing CPU resources, RAR aggregates Application B's and Application A's requests, effectively transferring resources from Application A to Application B, minimizing additional CPU requests to the virtualization system. The aggregated request is formatted as a single, optimized "CPU reallocation" request, enhancing efficiency. RAR then formats Application C's snapshot request as a standalone virtualization action, ensuring it is processed separately without affecting resource allocations.

The communication interface module (CIM) receives the optimized CPU reallocation request and the snapshot request from RAR. CIM establishes a secure connection with the virtualization system and sends both requests. The CPU reallocation request, combining Application A's release with Application B's additional CPU needs, is processed by the virtualization system as a single operation, while the snapshot request for Application C is sent as an independent command. CIM receives feedback from the virtualization system, confirming the successful CPU reallocation and the completion of Application C's snapshot request. This feedback is forwarded to the performance and feedback tracker (PFT), which monitors Application B's performance post-allocation to verify that the additional CPU resources meet its workload requirements. If PFT detects any potential CPU shortfall, it alerts the URM to reprioritize future requests to ensure that Application B's needs are continuously met. PFT logs the feedback and results of the CPU reallocation and snapshot request, updating its machine-learning model to optimize future resource predictions. Using this feedback data, PFT refines its predictions for similar requests and provides these insights to the PCM and URM, enabling the system to prioritize and aggregate requests more effectively in future scenarios.

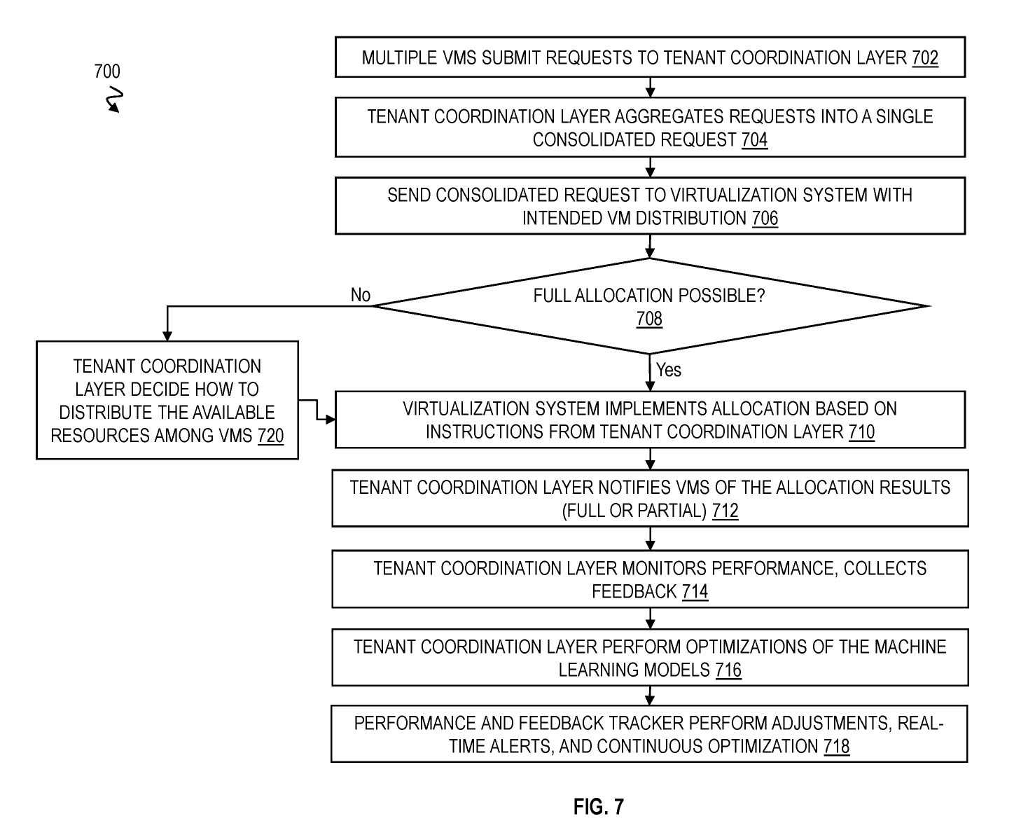

FIG. 7 illustrates a flow chart of a computer-implemented method 700 for managing resource allocation in a multi-tenant virtualized environment according to one or more embodiments. The method 700 begins at block 702, where multiple virtual machines (VMs) submit resource requests to the tenant coordination layer. For example, each VM may request additional CPU or memory resources to accommodate increased workload demands.

At block 704, the tenant coordination layer aggregates these requests into a single consolidated request. This step involves combining similar requests to streamline communication and reduce redundancy. For instance, if several VMs request additional CPU cores, the tenant coordination layer may merge these into a unified request for a total number of cores needed. Next, as shown at block 706, the consolidated request is sent to the virtualization system with the intended VM distribution. This involves specifying how the requested resources should be allocated across the VMs. For example, the request might indicate that certain VMs require more resources due to higher-priority tasks.

At decision block 708, the system determines whether full allocation of the requested resources is possible. If the virtualization system can meet the entire request, the process proceeds to block 710, where the virtualization system implements the allocation based on instructions from the tenant coordination layer. This may involve provisioning the necessary resources to each VM as specified. If the full allocation is not possible, the method moves to block 720, where the tenant coordination layer decides how to distribute the available resources among the VMs. This decision is based on tenant-specific policies and priorities, ensuring that critical applications receive the resources they need.

At block 712, the tenant coordination layer notifies the VMs of the allocation results, whether full or partial. This communication ensures that each VM is aware of the resources it has been allocated and can adjust its operations accordingly. The process continues at block 714, where the tenant coordination layer monitors performance and collects feedback. This involves tracking how well the allocated resources meet the VMs' needs and identifying any performance issues. At block 716, the tenant coordination layer performs optimizations of the machine learning models. This step uses the collected feedback to refine resource allocation strategies, improving future predictions and decisions.

The method 700 concludes at block 718, with the performance and feedback tracker providing adjustments, real-time alerts, and continuous optimization based on the feedback received. This ensures that resource management remains responsive and efficient over time, adapting to changing conditions and demands within the virtualized environment.

In an example scenario, multiple virtual machines (VMs) submit resource requests to the tenant coordination layer. The tenant coordination layer determines that full allocation of the requested resources is not possible with the current resources available. Faced with this limitation, the tenant coordination layer requests additional resources from the virtualization system. The virtualization system responds with various levels of additional resources that can be provided, each associated with a different cost. The tenant coordination layer evaluates these options, considering the additional costs and the pending requests based on the previously provided policies of the tenant. For example, the virtualization system might offer three levels of additional resources: a minimal level at a low cost, a moderate level at a medium cost, and a maximum level at a high cost. The tenant coordination layer reviews the tenant's policies, which may prioritize cost efficiency or performance, and decides on the most suitable level of additional resources to provision. After evaluating the options, the tenant coordination layer selects the desired level of additional resources that best aligns with the tenant's policies and budget constraints. It then responds to the virtualization system with this selection, requesting the provisioning of the chosen level of resources. Once the virtualization system implements the allocation based on the tenant coordination layer's instructions, the tenant coordination layer notifies the VMs of the allocation results, whether full or partial.

The QoS, priorities, and policies are used for resource allocation and coordination within a virtualized environment. QoS is a measure of service performance that defines the acceptable operational thresholds required by applications or tenants to maintain expected levels of functionality, responsiveness, and reliability. These standards typically encompass factors like latency, uptime, and resource availability, ensuring that critical applications receive a consistent level of performance even during high-demand periods. In this system, QoS serves as a guiding benchmark for the unified request manager and tenant coordination layer, processing requests in alignment with QoS requirements and prioritizing resources based on the need for higher service reliability or specific performance metrics. For example, a virtual machine (VM) hosting both a video conferencing application and a file backup service would prioritize the video conferencing application due to its strict QoS requirements for low latency and high video quality, ensuring that disruptions are minimized even if it means reducing resources for less critical applications like the file backup service.

Priorities, on the other hand, indicate the relative importance of a request within the VM or tenant framework. Unlike QoS, which establishes service thresholds, priorities directly impact the order in which requests are processed and fulfilled. The priorities can be assigned based on urgency, application type, user-defined rankings, or contextual requirements such as peak usage times or workload surges. Priorities dictate the handling order of requests when multiple demands arise simultaneously, ensuring that more critical or urgent requests are processed first. For instance, in a financial services VM with both a transaction processing application and a batch reporting tool, the transaction processing application would have a higher priority due to its real-time payment handling, ensuring it receives resources first even if both applications meet their QoS standards.

Policies are predefined rules set at the VM or tenant level that establish boundaries, permissions, and specific handling instructions for resource requests. These rules specify limits on resources, frequency of requests, conditions for granting access, and custom rules for handling exceptions or constraints. Policies help enforce resource caps, prevent misuse, and support specific governance or compliance requirements for tenants and VMs. They provide a structured framework that governs how QoS and priority settings are applied across requests, ensuring alignment with tenant-defined rules, VM-level restrictions, and overarching system goals. For example, a VM-level policy might allow an application to use up to 60% of CPU resources during peak usage, but a tenant-level policy could cap CPU usage at 50% for any individual VM, with the tenant-level policy taking precedence to ensure alignment with broader resource management strategies.

The interaction and coordination among QoS, priorities, and policies provide a layered approach to resource allocation and optimization. When a resource request is received, the system first evaluates its QoS requirements to understand the necessary service level, assigning priority levels to process the most critical tasks first. Policies act as governing rules that oversee both QoS and priority settings, ensuring fair and compliant resource allocation. In cases of conflict between VM-level and tenant-level policies, the system prioritizes the broader tenant-level policy, allowing each VM some degree of customization while adhering to higher-level restrictions. In summary, QoS defines baseline performance standards, priorities determine the order and urgency of request handling, and policies enforce resource limits and compliance, working together to achieve optimal resource allocation and maintain system stability across a multi-tenant environment.

In a multi-tenant environment, Tenant A has three virtual machines (VMs)—VM1, VM2, and VM3—each hosting different virtualization-aware applications capable of requesting resources. All three VMs share an allocation of CPU resources from the virtualization system. Suppose VM1 sends a request to increase its CPU allocation by 4 cores for a high-computation batch job, VM2 requests an additional 2 cores to handle a spike in user activity for a real-time application, and VM3 sends a request to release 1 core due to a reduced workload. In this scenario, VM1 and VM2 are asking for more CPU resources, while VM3 is releasing some. However, the available CPU resources may not be sufficient to fully satisfy both requests from VM1 and VM2, especially if other tenants are also making requests.

The tenant coordination layer employs a conflict resolution process to address this situation. Tenant-specific prioritization policies may indicate which VMs are more critical in resource allocation. For example, VM2, hosting the real-time application, might have a higher priority because it directly affects the end-user experience, while VM1, running a batch job, may have a lower priority since its task can be delayed without immediate impact. Based on these priorities, the tenant coordination layer could decide to fully allocate the 2 cores requested by VM2 to maintain the real-time application’s performance, while partially fulfilling VM1’s request by allocating 1 core instead of 4.

The tenant coordination layer aggregates VM3's release of 1 core and decides how best to redistribute it, potentially directing it to either VM1 or VM2 depending on priority and current needs. If VM1’s batch job can wait, the tenant coordination layer may defer its request for additional cores until more resources become available, either from other VMs within the tenant or based on feedback from the virtualization system. In this example, the tenant coordination layer has prioritized VM2's request for additional CPU to handle real-time demand, allocated a partial increase to VM1, and effectively managed the core release from VM3. This ensures that tenant-wide resource usage is optimized based on the importance of each request relative to tenant-defined priorities and current resource availability.

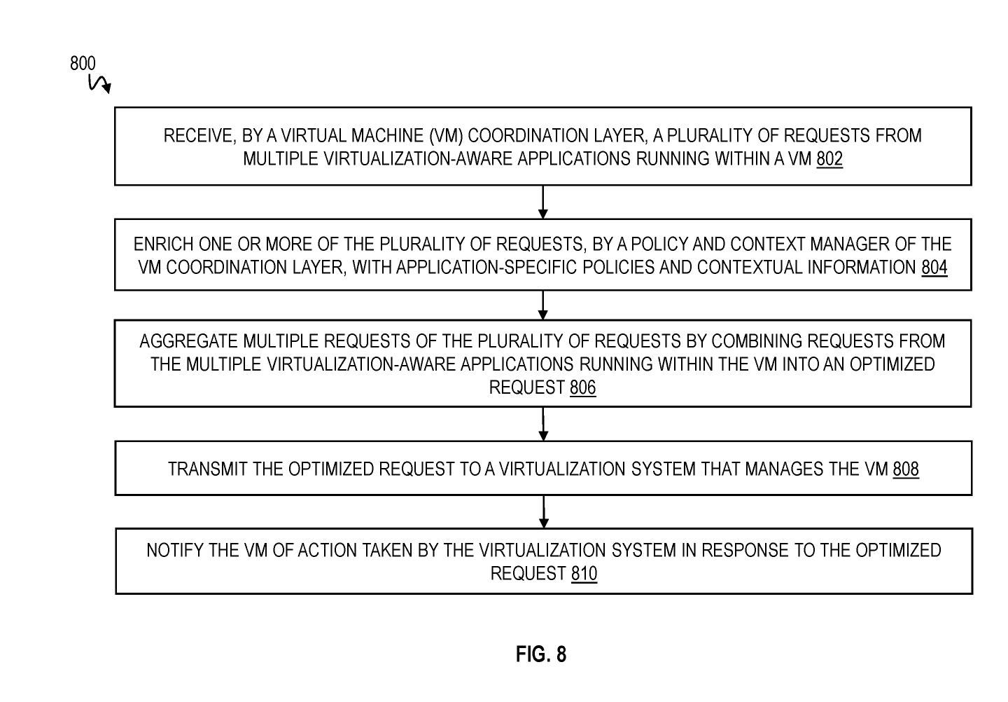

FIG. 8 illustrates a flow chart of a computer-implemented method 800 for managing resource requests in a virtualized environment according to one or more embodiments. The method 800 begins at step 802, where a virtual machine (VM) coordination layer receives a plurality of requests from multiple virtualization-aware applications running within a VM. This step initiates the process of centralized resource coordination by collecting all resource and virtualization-specific requests from the applications. The VM coordination layer acts as an intermediary, ensuring that each application's request is captured and processed efficiently, thereby streamlining the handling of requests and reducing potential conflicts.

Next, as shown at block 804, the method 800 includes the policy and context manager of the VM coordination layer enriching one or more of the plurality of requests with application-specific policies and contextual information. This enhancement process involves adding details such as task priority, workload type, and duration to each request, ensuring alignment with developer-defined policies and enabling context-aware resource allocation.

In an exemplary scenario, a VM hosts multiple virtualization-aware applications, each submitting resource requests to the VM coordination layer. Application A requests additional CPU resources to handle a surge in user activity, while Application B requests more memory to process a large dataset. As these requests are received, the policy and context manager of the VM coordination layer enriches these requests with application-specific policies and contextual information. For example, for Application A, the policy and context manager adds details such as a high task priority due to the real-time nature of the user activity, a workload type indicating interactive processing, and a short duration reflecting the temporary spike in demand. This enrichment ensures that Application A's request is aligned with developer-defined policies that prioritize real-time applications, enabling context-aware resource allocation. Similarly, for Application B, the policy and context manager enriches the request with a medium task priority, given that the data processing task is important but not time-sensitive. The workload type is marked as batch processing, and the duration is set to a longer period, reflecting the extended time required for data analysis. This contextual information allows the system to allocate resources to Application B in a manner that aligns with its processing needs without compromising the performance of higher-priority tasks. By enriching these requests with contextual information, the policy and context manager ensures that each application's resource needs are met efficiently and in accordance with predefined policies, facilitating optimal resource allocation within the VM.

Next, as shown at block 806, the method 800 includes aggregating multiple requests by combining them into an optimized request. In exemplary embodiments, a request aggregation and resource generation module of the VM coordination layer is responsible for consolidating similar or redundant resource requests into a single, optimized request, minimizing redundant communications with the virtualization system, and enhancing resource utilization.

In one example, a VM hosts multiple virtualization-aware applications, each with distinct resource needs. Application X requires additional CPU resources to process a data-intensive task, while Application Y requests more memory to handle a temporary increase in user sessions. Simultaneously, Application Z seeks additional network bandwidth to support a live-streaming event. In exemplary embodiments, these requests are aggregated into an optimized request. The request aggregation and resource generation module of the VM coordination layer identifies the commonalities and redundancies among these requests. For instance, both Applications X and Y may have overlapping CPU and memory requirements that can be addressed collectively. The module consolidates these similar requests, reducing the need for separate communications with the virtualization system. By combining the CPU and memory requests from Applications X and Y, along with the network bandwidth request from Application Z, the module creates a single, optimized request. This aggregated request minimizes redundant communications with the virtualization system, enhancing resource utilization and ensuring that the VM's overall resource demands are met efficiently.

Once the requests are aggregated, the method 800 includes transmitting the optimized request to a virtualization system that manages the VM, as shown at block 808. In exemplary embodiments, a communication interface module handles this transmission, ensuring that the optimized request is sent securely and efficiently to the virtualization system, maintaining standardized communication settings and configurations for consistent interactions.

Next, as shown at block 810, the method 800 also includes notifying the VM of the action taken by the virtualization system in response to the optimized request. This notification process keeps the VM, and its applications informed about the status of their resource requests. In exemplary embodiments, the notifying the VM and its applications about the status of their resource requests offers several benefits. First, it enhances transparency and allows applications to adjust their operations based on the current resource availability. This real-time feedback enables applications to optimize their performance by adapting to the resources they have been allocated, ensuring they can operate efficiently without overloading the system.

For example, consider a VM running a data analytics application that processes large datasets. The application experiences a surge in incoming data, prompting it to request additional CPU and memory resources to handle the increased workload efficiently. Upon receiving a notification that the requested resources have been allocated, the VM can dynamically adjust its operations to take advantage of the enhanced capacity. With the additional CPU resources, the application can increase the number of parallel processing threads, allowing it to process data more quickly and reduce the time required to generate insights. The extra memory allocation enables the application to load larger datasets into memory, minimizing the need for disk I/O operations and further speeding up data processing. As a result of these adjustments, the application can maintain its performance levels despite the increased data volume, ensuring timely delivery of analytics results to users. This proactive adaptation not only optimizes resource utilization but also enhances the application's ability to meet service level agreements (SLAs) and user expectations. By responding to the notification of additional resources, the VM effectively leverages the allocated capacity to improve operational efficiency and maintain high performance.

In exemplary embodiments, keeping applications informed about the status of their resource requests allows the VM to improve the planning and scheduling of tasks. Applications can prioritize or defer certain operations based on the confirmation of resource allocation, leading to more effective workload management and reduced risk of resource contention. Furthermore, informing VMs and applications about the status of their resource requests can facilitate more accurate logging and auditing. This information can be used to track resource usage patterns and support compliance with service level agreements (SLAs), ensuring that the system meets its performance and reliability commitments.

In an exemplary embodiment, a performance and feedback tracker of the VM coordination layer collects feedback on resource sufficiency and virtualization-specific actions, allowing for adaptive adjustments to future resource allocations. In exemplary embodiments, the performance and feedback tracker within the VM coordination layer continuously monitors resource utilization and collects feedback on the sufficiency of allocated resources. This involves tracking metrics such as CPU usage, memory consumption, and network bandwidth in real-time, while also logging any virtualization-specific actions taken, such as resource scaling or reallocation, to provide a comprehensive view of the system's performance. The collected feedback is then analyzed using machine learning algorithms that identify patterns and trends in resource usage. For instance, if an application consistently underutilizes its allocated resources, the system recognizes this pattern and adjusts future allocations accordingly. Similarly, if certain applications experience periodic spikes in demand, the system anticipates these needs and proactively allocates additional resources during peak times.

Based on the insights gained from data analysis, the system dynamically adjusts resource allocations to optimize performance. This may involve reallocating resources from underutilized applications to those experiencing higher demand or adjusting the quantity and type of resources allocated to better match application requirements. These adjustments are made in real-time, ensuring that the system remains responsive to changing conditions. Furthermore, the system leverages historical data to refine its resource management strategies. By comparing current performance metrics with historical trends, the system can make informed predictions about future resource needs and adjust allocations to prevent bottlenecks or resource shortages. This historical perspective allows the system to continuously improve its efficiency and effectiveness over time.

In one embodiment, the VM coordination layer employs a performance monitoring module that continuously tracks the resource usage and performance metrics of virtualization-aware applications within the VM. The performance monitoring is configured to collect data at regular intervals, allowing for real-time analysis and adjustments. In another embodiment, the VM coordination layer utilizes a machine learning algorithm that processes historical performance data to predict future resource needs, enabling proactive resource allocation adjustments. This algorithm can be trained using various data sets, including CPU usage, memory consumption, and network bandwidth, to enhance predictive accuracy. Additionally, the VM coordination layer may incorporate a feedback loop mechanism that dynamically adjusts resource allocations based on real-time performance feedback, ensuring optimal application performance.

In various embodiments, a system for resolving conflicts among concurrent requests from different virtualization-aware applications can be implemented with diverse configurations and operational methods. In one embodiment, the VM coordination layer employs a rule-based conflict resolution mechanism, where predefined rules determine the priority of requests based on application type, urgency, or historical performance data. This approach allows for quick decision-making in high-demand environments. In another embodiment, the VM coordination layer utilizes a machine learning model that dynamically learns from past interactions to predict and resolve potential conflicts, adapting to changing application behaviors and resource availability. This model can be trained using historical data to improve its accuracy over time. Additionally, the VM coordination layer may incorporate a feedback loop that continuously monitors the outcomes of conflict resolution decisions, allowing for real-time adjustments to the prioritization criteria. In yet another embodiment, the VM coordination layer could integrate a user-defined policy framework, enabling administrators to customize conflict resolution strategies based on specific organizational needs or service level agreements (SLAs). This flexibility ensures that the VM coordination layer can be tailored to meet the specific requirements of different virtualized environments, enhancing its adaptability and effectiveness in managing resource contention.

In one embodiment, the tenant coordination layer is implemented as a software module within a cloud management platform, designed to aggregate and optimize resource requests from multiple VM coordination layers. This software module can dynamically adjust resource allocation strategies based on real-time data analytics, ensuring efficient distribution of resources across VMs. In another embodiment, the tenant coordination layer is configured as a standalone middleware application that interfaces with various VM coordination layers through standardized APIs, allowing for seamless integration with different virtualization systems. This middleware can be deployed on dedicated servers to handle high volumes of resource requests, providing scalability and robustness in large-scale multi-tenant environments. In yet another embodiment, the tenant coordination layer incorporates machine learning algorithms to predict future resource demands based on historical usage patterns, enabling proactive resource management and reducing latency in resource provisioning. Additionally, the tenant coordination layer can be customized to support tenant-specific policies, such as prioritizing important applications during peak demand periods, thereby enhancing the QoS for each tenant.

In one embodiment, the tenant coordination layer is implemented as a software module that resides on a dedicated server within the cloud environment, managing communication between the VM coordination layers and the virtualization system. This configuration allows for centralized processing and optimization of resource requests, ensuring efficient handling of high volumes of data. In another embodiment, the tenant coordination layer is integrated directly into the virtualization system's management software, providing seamless interaction and reducing latency in request processing. This integration can enhance the system's ability to apply tenant-specific policies and prioritize resource allocation based on real-time demands. Alternatively, the tenant coordination layer could be distributed across multiple nodes within the cloud infrastructure, allowing for scalability and redundancy. This distributed approach can improve fault tolerance and ensure continuous operation even if one node fails. Additionally, the tenant coordination layer may employ different algorithms for prioritizing requests, such as machine learning-based models that adapt to changing workloads and optimize resource distribution dynamically. These variations demonstrate the flexibility of the tenant coordination layer in adapting to different operational requirements and infrastructure setups while maintaining its fundamental functionality of managing resource requests across multiple VMs within a tenant.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

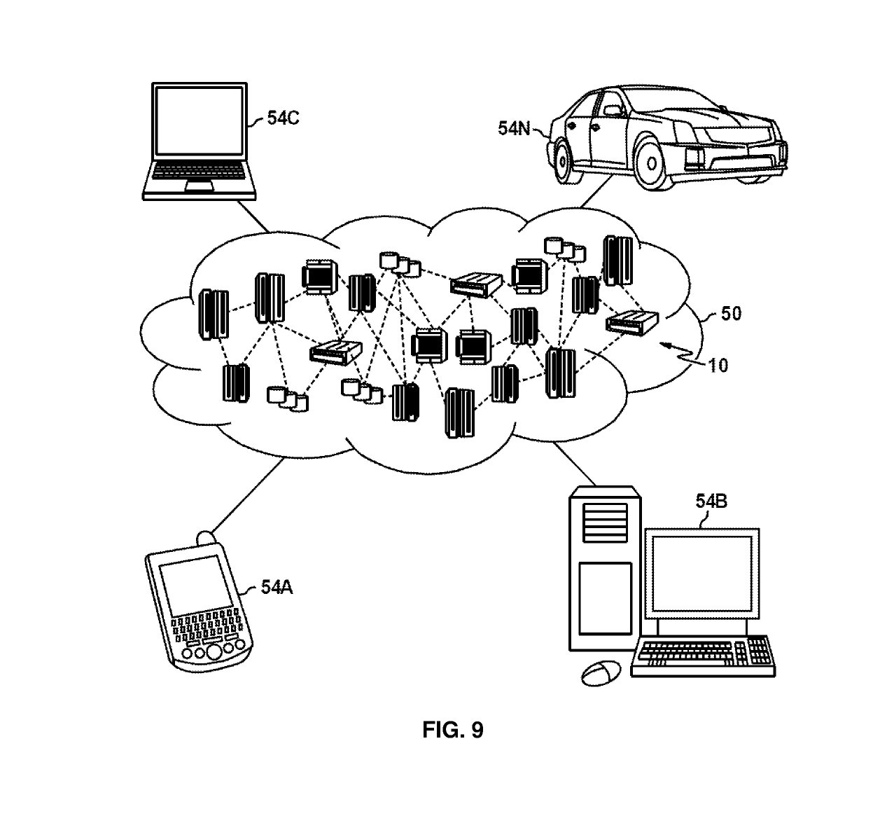

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

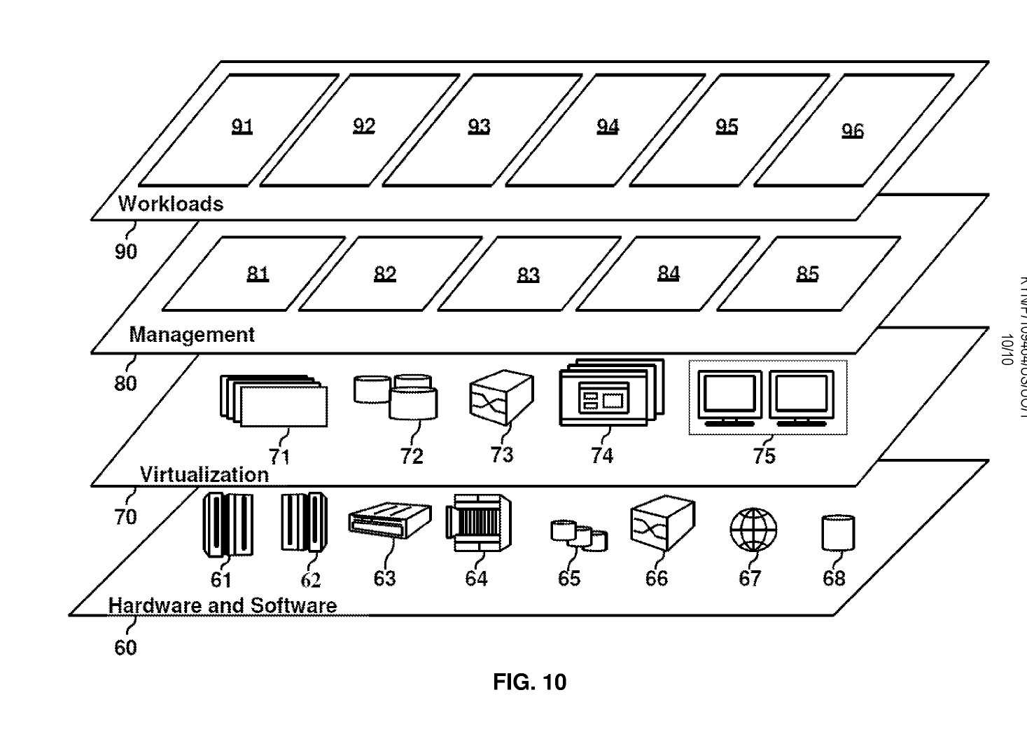

Referring now to FIG. 10, a set of functional abstraction layers provided by cloud computing environment 50 (depicted in FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. One or more aspects of embodiments may be executed, at least in part, by workloads and functions 96. In one or more embodiments, the generative AI model 242, etc., can utilize, be executed as, and/or be integrated with workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purpose of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flow chart illustrations and/or block diagrams of methods, apparatus (systems), and computer program products according to embodiments of the invention. It will be understood that each block of the flow chart illustrations and/or block diagrams, and combinations of blocks in the flow chart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow chart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flow chart and/or block diagram block or blocks.

The flow chart and block diagrams in the Figures illustrate the architecture, functionality, and operation of possible implementations of systems, methods, and computer program products according to various embodiments of the present invention. In this regard, each block in the flow chart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flow chart illustration, and combinations of blocks in the block diagrams and/or flow chart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for centralized resource coordination and optimization for virtualization-aware applications in a multi-tenant virtualized environment, comprising:
receiving, by a virtual machine (VM) coordination layer, a plurality of requests from multiple virtualization-aware applications running within a VM;
enriching one or more of the plurality of requests, by a policy and context manager of the VM coordination layer, with application-specific policies and contextual information;
aggregating multiple requests of the plurality of requests by combining requests from the multiple virtualization-aware applications running within the VM into an optimized request;
transmitting the optimized request to a virtualization system that manages the VM; and
notifying the VM of action taken by the virtualization system in response to the optimized request, wherein the VM is configured optimize its performance based on the action taken by the virtualization system.

2. The computer-implemented method of claim 1, further comprising:
monitoring performance and resource usage of the multiple virtualization-aware applications running within the VM; and
enabling adaptive adjustments to future resource allocations and using machine learning algorithms to analyze historical data regarding the performance and resource usage of the multiple virtualization-aware applications running within the VM.

3. The computer-implemented method of claim 1, further comprising prioritizing, by the VM coordination layer, the plurality of requests based on predefined quality of service policies of the VM.

4. The computer-implemented method of claim 1, further comprising, resolving conflicts among concurrent requests from different applications of the multiple virtualization-aware applications, by the VM coordination layer, to avoid resource contention.

5. The computer-implemented method of claim 1, further comprising applying rate limiting, by the VM coordination layer, to control a frequency and volume of requests forwarded by the VM to the virtualization system.

6. The computer-implemented method of claim 1, wherein the VM is associated with a tenant of a cloud environment managed by the virtualization system and wherein the optimized request is transmitted to the virtualization system via a tenant coordination layer that manages a plurality of VMs including the VM.

7. The computer-implemented method of claim 6, wherein the tenant coordination layer is configured to aggregate and optimize resource requests, received from multiple VM coordination layers of the VMs of the tenant.

8. The computer-implemented method of claim 6, wherein all communication between the VM coordination layers of the VMs of the tenant and the virtualization system is handled by the tenant coordination layer.

9. The computer-implemented method of claim 6, wherein the tenant coordination layer is configured to provide tenant-specific prioritization and policy application for strategic allocation of resources across VMs based on tenant-defined requirements and QoS policies.

10. A device comprising:
a memory having computer readable instructions; and
one or more processors for executing the computer readable instructions, the computer readable instructions when executed cause the one or more processors to perform operations comprising:
receiving, by a virtual machine (VM) coordination layer, a plurality of requests from multiple virtualization-aware applications running within a VM;
enriching one or more of the plurality of requests, by a policy and context manager of the VM coordination layer, with application-specific policies and contextual information;
aggregating multiple requests of the plurality of requests by combining requests from the multiple virtualization-aware applications running within the VM into an optimized request;
transmitting the optimized request to a virtualization system that manages the VM; and
notifying the VM of action taken by the virtualization system in response to the optimized request, wherein the VM is configured optimize its performance based on the action taken by the virtualization system.

11. The device of claim 10, wherein the operations further comprise:
monitoring performance and resource usage of the multiple virtualization-aware applications running within the VM; and
enabling adaptive adjustments to future resource allocations and using machine learning algorithms to analyze historical data regarding the performance and resource usage of the multiple virtualization-aware applications running within the VM.

12. The device of claim 10, wherein the operations further comprise prioritizing, by the VM coordination layer, the plurality of requests based on predefined quality of service policies of the VM.

13. The device of claim 10, wherein the operations further comprise resolving conflicts among concurrent requests from different applications of the multiple virtualization-aware applications, by the VM coordination layer, to avoid resource contention.

14. The device of claim 10, wherein the operations further comprise applying rate limiting, by the VM coordination layer, to control a frequency and volume of requests forwarded by the VM to the virtualization system.

15. The device of claim 10, wherein the VM is associated with a tenant of a cloud environment managed by the virtualization system and wherein the optimized request is transmitted to the virtualization system via a tenant coordination layer that manages a plurality of VMs including the VM.

16. The device of claim 15, wherein the tenant coordination layer is configured to aggregate and optimize resource requests, received from multiple VM coordination layers of the VMs of the tenant.

17. The device of claim 15, wherein all communication between the VM coordination layers of the VMs of the tenant and the virtualization system is handled by the tenant coordination layer.

18. The device of claim 15, wherein the tenant coordination layer is configured to provide tenant-specific prioritization and policy application for strategic allocation of resources across VMs based on tenant-defined requirements and QoS policies.

19. A computer program product comprising a computer readable storage medium having program instructions embodied therewith, the program instructions executable by one or more processors to cause the one or more processors to perform operations comprising:
receiving, by a virtual machine (VM) coordination layer, a plurality of requests from multiple virtualization-aware applications running within a VM;
enriching one or more of the plurality of requests, by a policy and context manager of the VM coordination layer, with application-specific policies and contextual information;
aggregating multiple requests of the plurality of requests by combining requests from the multiple virtualization-aware applications running within the VM into an optimized request;
transmitting the optimized request to a virtualization system that manages the VM; and
notifying the VM of action taken by the virtualization system in response to the optimized request, wherein the VM is configured optimize its performance based on the action taken by the virtualization system.

20. The computer program product of claim 19, wherein the operations further comprise:
monitoring performance and resource usage of the multiple virtualization-aware applications running within the VM; and
enabling adaptive adjustments to future resource allocations and using machine learning algorithms to analyze historical data regarding the performance and resource usage of the multiple virtualization-aware applications running within the VM.
